(19) United States
(12) Patent Application Publication
(10) Pub. No.: US 2026/0292386 A1
(43) Pub. Date: Sep. 24, 2026

(54) OPEN-TYPE EARPHONE

(71) Applicant: SHENZHEN GRANDSUN ELECTRONIC CO., LTD., Shenzhen, Guangdong (CN)

(72) Inventors: Jiugao PENG, Shenzhen (CN); Haiquan WU, Shenzhen (CN); Chuan WANG, Shenzhen (CN); Ruiwen SHI, Shenzhen (CN); Zhijun ZHANG, Shenzhen (CN)

(73) Assignee: SHENZHEN GRANDSUN ELECTRONIC CO., LTD., Shenzhen, Guangdong (CN)

(21) Appl. No.: 18/039,123

(22) PCT Filed: Apr. 13, 2023
(86) PCT No.: PCT/CN2023/088175

§ 371 Date: Mar. 6, 2026

(30) Foreign Application Priority Data
Sep. 15, 2022 (CN) 202211121393.2

(51) Int. Cl. H04R 1/10; H04R 1/02; H04R 1/1025

(52) U.S. Cl. CPC H04R 1/105; H04R 1/023; H04R 1/028; H04R 1/1016; H04R 1/1025; H04R 1/1033; H04R 1/1041; H04R 1/1066; H04R 2201/10

(57) ABSTRACT

Provided is an open-type earphone, the open-type earphone includes an earphone body (100) and an ear hook (200), the ear hook (200) includes a curved section (210) and an auxiliary section (220), one end of the curved section is connected to one end of the auxiliary section, and the other end of the curved section is rotatably connected to the earphone body, the curved section is made of a soft material, and the auxiliary section is made of a hard material. When worn, the curved section is hung on the upper part of the user's outer auricle, the auxiliary section is fitted on the back of the user's outer auricle, and the earphone body is fitted on the user's inner auricle. The shape of the curved section can be adaptively adjusted according to the shape of the outer auricle of the user. The auxiliary section can improve the stability of the user when worn, and the auxiliary section is connected to the earphone body through the curved section so that the earphone body can rotate relative to the ear hook for better fitting on the user's inner auricle.

This application claims the benefit of Chinese patent application No. 202211121393.2 filed on Sep. 15, 2022, titled “Open-Type Earphone”, the entire contents of which are incorporated herein by reference.

### TECHNICAL FIELD

The present application relates to earphones, and in particular, to an open-type earphone.

### BACKGROUND

With the improvements in the quality of life, earphones have become widely used as an intermediary for connection with electronic communication equipment and have been an essential part of daily life. Wireless earphones are favored by consumers because of their small size and portability. Wireless earphones are roughly divided into two types: in-ear wireless earphones and open-type earphones. In-ear wireless earphones are used with speakers plugged into the consumer's ear canal, and open-type earphones are used with speakers worn outside the consumer's ear canal.

The current open-type earphones mainly adopt ear hooks to hang on the outer auricle of the user, but the ear hooks are generally made of hard materials, and the shape of the ear hooks cannot be adaptively adjusted according to the shape of the user's outer auricle, therefore, it is easy to cause pain to the user after wearing for a long time, resulting in poor comfort for the user.

### TECHNICAL PROBLEMS

An embodiment of the present application provides an open-type earphone to tack the problem that existing earphones adopt ear hooks which are generally made of hard materials to hang on the outer auricle of the user, and the shape of the ear hooks cannot be adaptively adjusted according to the shape of the user's outer auricle, causing pain to the user after wearing for a long time.

### TECHNICAL PROPOSALS

A technical proposal in an embodiment of the present application provides:

An open-type earphone, including:
an earphone body; and
an ear hook having a curved section and an auxiliary section, one end of the curved section is connected to one end of the auxiliary section, and the other end of the curved section is rotatably connected to the earphone body, the curved section is made of soft material, and the auxiliary section is made of hard material.

In an embodiment, the curved section is a soft rubber strip.

In an embodiment, a shape memory wire is embedded in the curved section.

In an embodiment, a material of the shape memory wire is a memory metal or a shape memory polymer.

In an embodiment, the ear hook also includes a first connecting block and a second connecting block, the first connecting block and the second connecting block are respectively embedded in the curved section, and two ends of the shape memory wire are respectively connected to the first connecting block and the second connecting block.

In an embodiment, a cross-sectional area of the curved section gradually increases in directions from a middle part toward two ends at the auxiliary section and the earphone body respectively.

In an embodiment, a cross-sectional area of the auxiliary section gradually decreases in a direction toward the curved section.

In an embodiment, a rotatory assembly is further provided, the rotatory assembly includes a connecting shaft, a connecting sleeve and a restoring elastic member, the connecting sleeve is movably sleeved on the connecting shaft, the connecting shaft is connected to the curved section, and the connecting sleeve is connected to the earphone body, the restoring elastic member is disposed on the connecting shaft and inside the connecting sleeve, and the restoring elastic member is configured to provide a restoring force to the connecting sleeve.

In an embodiment, the restoring elastic member is a torsion spring and is sleeved on the connecting shaft, and one end of the restoring elastic member is abutted against the earphone body or the connecting sleeve.

In an embodiment, the earphone body includes a housing, a circuit board, and a speaker, the housing is provided with a sound outlet hole and a tuning hole, the circuit board and the speaker are disposed in the housing, and the speaker and the circuit board are electrically connected.

In an embodiment, a first dust-proof net is provided at the sound outlet; and/or, a second dust-proof net is provided at the tuning hole.

In an embodiment, a light-transmitting area is provided on the housing, and the earphone body further includes an indicator light arranged in the housing, the indicator light is positioned corresponding to the light-transmitting area and is electrically connected to the circuit board.

In an embodiment, the earphone body also includes a magnetic member, the magnetic member is arranged in the housing, so that when the open-type earphone is placed in an earphone charging cartridge, the magnetic member attracts the earphone charging cartridge.

In an embodiment, a mounting cavity is provided in the auxiliary section, a battery is arranged in the mounting cavity, and a wiring harness is embedded in the curved section, one end of the wiring harness extends into the mounting cavity and is electrically connected to the battery, and the other end of the wiring harness extends into the housing and is electrically connected to the circuit board.

In an embodiment, the earphone body further includes an adapting member, the adapting member is disposed in the housing, one end of the adapting member is electrically connected to the speaker, and the other end is abutted against the circuit board.

In an embodiment, the adapting member includes a first connecting sheet, a second connecting sheet, and a flexible piece, the first connecting sheet and the second connecting sheet are spaced apart facing each other, and two ends of the flexible piece are respectively connected to one end of the first connecting sheet and the second connecting sheet, the first connecting sheet is electrically connected to the speaker, and the second connecting sheet is flexibly abutted on the circuit board.

In an embodiment, the earphone body also includes a separation plate, and the separation plate is arranged in the housing to separate an interior of the housing into a sound chamber and an accommodating chamber, the circuit board is arranged in the accommodating chamber, and the speaker is arranged in the sound chamber, the sound outlet hole and the tuning hole are both in communication with the sound chamber.

In an embodiment, the separation plate is recessed from the speaker toward the circuit board to form a recess, and a part of the speaker is disposed in the recess.

In an embodiment, a touch area is provided on the housing, and the earphone body further includes a touch panel, the touch panel is disposed in the housing, corresponding to the touch area, and the touch panel is electrically connected to the circuit board.

In an embodiment, the housing is provided with a first surface and a second surface facing away from each other, the sound outlet hole extends through the first surface, and the touch area is arranged on the second surface.

### ADVANTAGEOUS EFFECTS

The advantageous effects of the embodiments of the present application compared with the existing technology are that: the open-type earphone has a curved section made of a soft material, so that the curved section can be adjusted according to the outer auricle of the user; and since the curved section provides flexibility, the user will not feel pain. The auxiliary section is made of a hard material, which can provide structural stability to the ear hook, thereby improving the stability when worn by the user, the auxiliary section is rotatably connected to the earphone body through the curved section, so that the earphone body rotatable relative to the ear hook, thereby better fitting the inner auricle of the user and providing comfort to the user.

### BRIEF DESCRIPTION OF THE DRAWINGS

In order to more clearly illustrate the technical proposals in the embodiments of the present application, the accompanying drawings used in the embodiments or exemplary technical descriptions will be briefly introduced. Obviously, the accompanying drawings in the following descriptions are only some embodiments of the present application, those skilled in the art can also obtain other drawings based on these drawings without creative efforts.

FIG. 1 is a first perspective view of the open-type earphone according to an embodiment of the present application;

FIG. 2 is an exploded view of the open-type earphone according to the embodiment of the present application;

FIG. 3 is a second perspective view of the open-type earphone according to the embodiment of the present application;

FIG. 4 is a third perspective view of the open-type earphone according to the embodiment of the present application;

FIG. 5 is a cross-sectional view of the earphone body according to the embodiment of the present application;

FIG. 6 is a first partial structural view of the earphone body according to the embodiment of the present application;

FIG. 7 is a second partial structural view of the earphone body according to the embodiment of the present application;

FIG. 8 is a structural view of the ear hook omitting the second battery case according to the embodiment of the present application; and

FIG. 9 is the structural view of the rotatory assembly according to the embodiment of the present application.

Reference signs shown in the above drawings are as follows: 100, earphone body; 10, housing; 11, first surface; 111, sound outlet hole; 112 through hole; 12, second surface; 13, top surface; 131, tuning hole; 14, bottom surface; 15, sound chamber; 16, accommodating chamber; 17, first dust-proof net; 18, second dust-proof net; 20, circuit board; 21, notch; 30, speaker; 40, separation plate; 41, recess; 42, avoidance hole; 43, penetrating hole; 50, touch panel; 51, light-transmitting hole; 60, sensor; 70, indicator light; 80, charging probe; 81, magnetic member; 90, adapting member; 91, first connecting sheet; 92, second connecting sheet; 93, flexible piece; 200, ear hook; 210, curved section; 211, shape memory wire; 212, wiring harness; 220, auxiliary section; 221, mounting cavity; 222, battery; 223, first battery case; 224, second battery case; 230, first connecting block; 240, second connecting block; 300, rotatory assembly; 310, connecting shaft; 320, connecting sleeve; and 330, restoring elastic member.

### DETAILED DESCRIPTION OF THE EMBODIMENTS

In order to make the purpose, technical proposals, and advantages of the present application more clearly understood, the present application will be further described in detail below in conjunction with the accompanying drawings and embodiments. It should be understood that the specific embodiments described here are only for the purpose of explaining the present application, not to limit the present application.

It should be noted that when a component is referred to as being “fixed on” or “disposed on” another component, it may be directly on the other component or indirectly on the other component. When a component is referred to as being “connected to” another component, it may be directly or indirectly connected to the other component. The orientations or positional relationships indicated by terms “upper”, “lower”, “left”, “right”,” etc. are based on the orientations or positional relationships shown in the drawings, and are only for the convenience of describing the application, rather than indicating or implying the referred device or elements must have a specific orientation, be constructed and operated in a specific orientation, and thus should not be construed as limiting the application, and those of ordinary skill in the art can understand the specific meanings of the above terms according to specific situations. The terms “first” and “second” are only used for descriptive purposes, and cannot be understood as indicating or implying relative importance or implicitly specifying the quantity of technical features. “A plurality of” means two or more, unless otherwise clearly and specifically defined.

In order to illustrate the technical proposals provided by the present application, detailed descriptions will be given below in conjunction with specific drawings and embodiments.

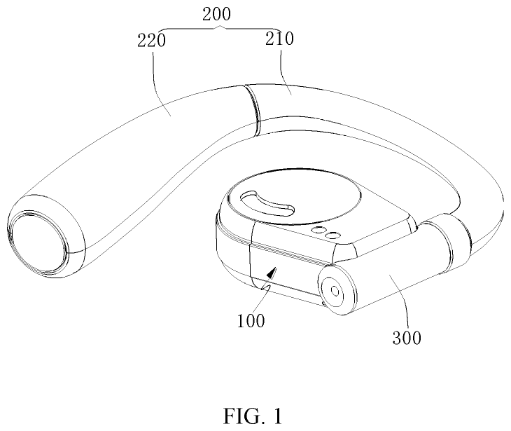

Referring to FIG. 1, an open-type earphone provided by an embodiment of the present application includes an earphone body 100 and an ear hook 200 having a curved section 210 and an auxiliary section 220, one end of the curved section 210 is connected to one end of the auxiliary section 220, and the other end of the curved section 210 is rotatably connected to the earphone body 100, the curved section 210 is made of soft material, and the auxiliary section 220 is made of hard material.

When wearing the open-type earphone of the present application, the curved section 210 of the ear hook 200 is hung on the upper part of the user's outer auricle, the auxiliary section 220 is fitted on the back of the user's outer auricle, and the earphone body 100 is fitted on the user's inner auricle. The open-type earphone has a curved section 210 made of a soft material, so that the curved section 210 can be adjusted according to the outer auricle of the user; and since the curved section 210 provides flexibility, the user will not feel pain. The auxiliary section 220 is made of a hard material, which can provide structural stability to the ear hook 200, thereby improving the stability when worn by the user, the auxiliary section 220 is rotatably connected to the earphone body 100 through the curved section 210, so that the earphone body 100 rotatable relative to the ear hook 200, thereby better fitting the inner auricle of the user and providing comfort to the user.

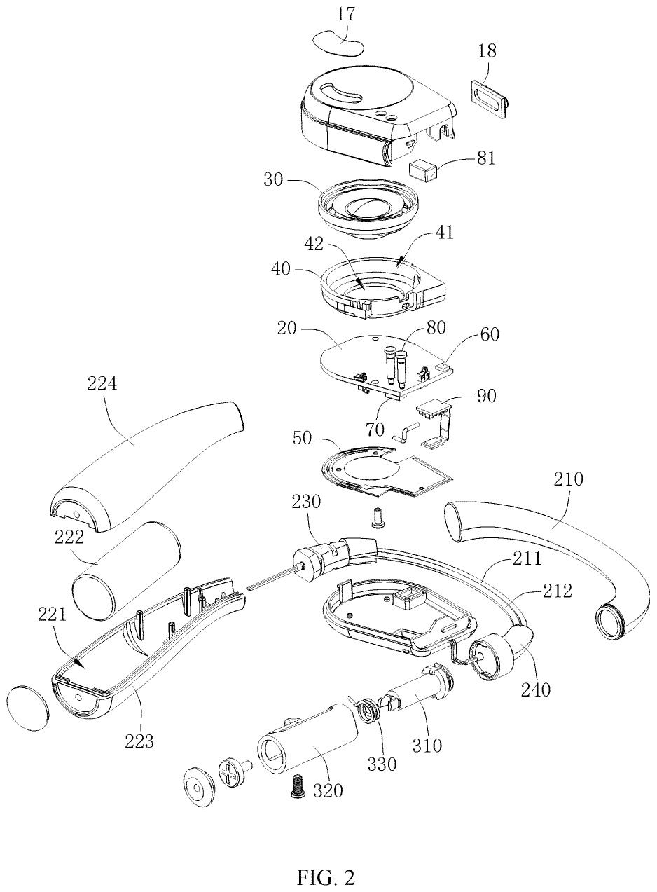

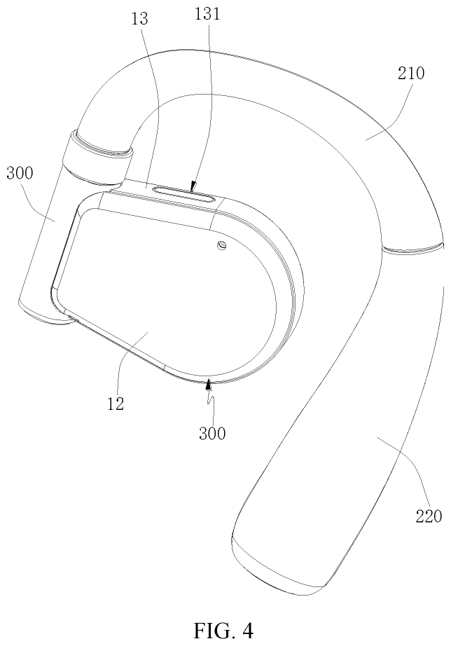

Referring to FIGS. 2 to 5, in some embodiments of the present application, the earphone body 100 includes a housing 10, a circuit board 20, and a speaker 30. The housing 10 is provided with a sound outlet hole 111 and a tuning hole 131, the circuit board 20 and the speaker 30 are both arranged in the housing 10, and the speaker 30 and the circuit board 20 are electrically connected.

Specifically, the housing 10 is provided with a first surface 11, a second surface 12, a top surface 13, and a bottom surface 14. The first surface 11 and the second surface 12 are arranged facing away from each other. The top surface 13 and the bottom surface 14 are arranged between the first surface 11 and the second surface 12, and the top surface 13 faces the bottom surface 14. It can be understood that when worn, the first surface 11 is the front side, and the first surface 11 fits the inner auricle of the user, and the second surface 12 is the back side, and the second surface 12 faces away from the user's ear. The sound outlet hole 111 extends through the first surface 11 and is positioned close to the bottom surface 14. The tuning hole 131 extends through the top surface 13 and is positioned diagonally to the sound outlet hole 111, so that the tuning hole 131 is positioned at a distance from the sound outlet hole 111, which effectively prevents the mid-low frequency sound waves transmitted through the sound outlet hole 111 from canceling out the mid-low frequency sound waves transmitted through the tuning hole 131, reduces the loss of mid-low frequency sound waves in the earphone audio, and improves the sound pressure of the mid-low frequency sound waves, thereby improving the mid-low frequency effect in the audio.

In some embodiments of the present application, a first dust-proof net 17 is provided at the sound outlet hole 111, which effectively prevents external dust from entering the sound chamber 15 through the sound outlet hole 111.

In some embodiments of the present application, a second dust-proof net 18 is provided at the tuning hole 131, which effectively prevents external dust from entering the sound chamber 15 through the tuning hole 131.

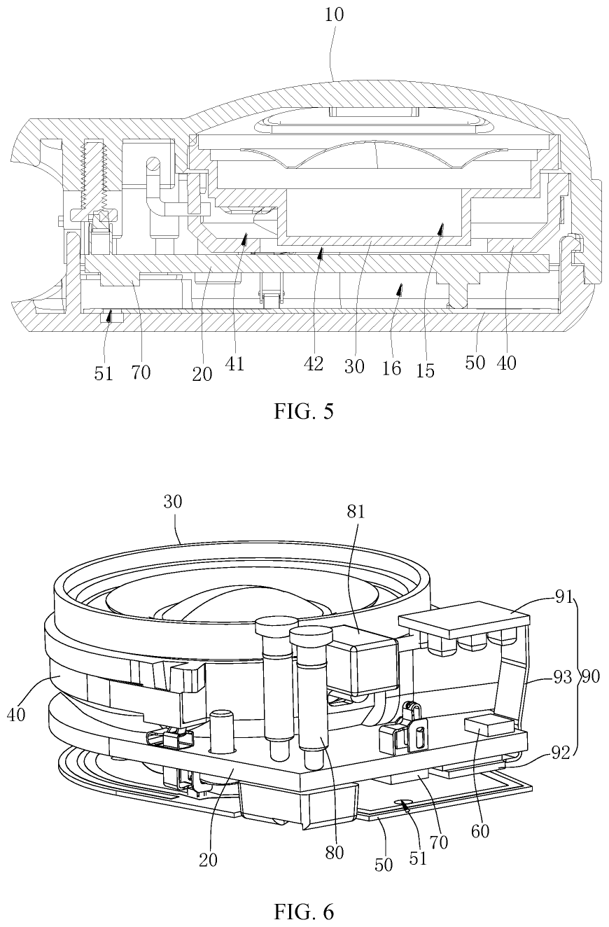

Referring to FIGS. 2 and 5, in some embodiments of the present application, the earphone body 100 also includes a separation plate 40 arranged in the housing 10, to separate the interior of the housing 10 into a sound chamber 15 and an accommodating chamber 16, the sound chamber 15 and the accommodating chamber 16 are not communicated with each other, and the circuit board 20 is disposed in the accommodating chamber 16, the speaker 30 is disposed in the sound chamber 15, and the sound outlet hole 111 and the tuning hole 131 are both in communication with the sound chamber 15. By arranging the circuit board 20 and the speaker 30 in the sound chamber 15 and the accommodating chamber 16 which are not communicated with each other, it is possible to effectively prevent the liquid that enters the sound chamber 15 through the sound outlet hole 111 and the tuning hole 131 from flowing onto the circuit board 20, resulting in damage to the circuit board 20.

In some embodiments of the present application, the separation plate 40 is recessed from the speaker 30 to the circuit board 20 to form a recess 41, and a part of the speaker 30 is arranged in the recess 41, effectively reducing the space occupied by the separation plate 40 inside the housing 10. Specifically, an avoidance hole 42 is provided on the bottom of the separation plate 40 corresponding to the recess 41, the avoidance hole 42 communicates with the recess 41, and a part of the speaker 30 extends into the avoidance hole 42, which can effectively reduce the overall size of the earphone body 100, minimizing the size of the earphone.

In some embodiments of the present application, a first waterproof glue is filled in and seals the avoidance hole 42.

In some embodiments of the present application, the separation plate 40 is provided with a wiring hole for the wires that electrically connect the speaker 30 and the circuit board 20 to pass through.

In some embodiments of the present application, the wiring hole is filled with a second waterproof glue to seal the wire passing hole.

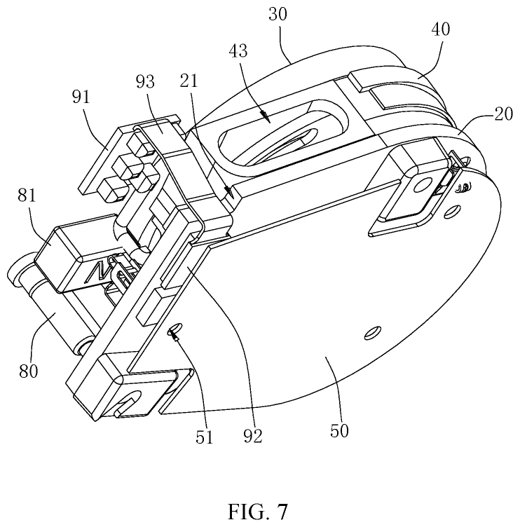

In some embodiments of the present application, the separation plate 40 is provided with a penetrating hole 43, as shown in FIG. 7, the penetrating hole 43 communicates with the tuning hole 131 correspondingly.

In some embodiments of the present application, referring to FIGS. 2 and 5 to 7, the housing 10 is provided with a touch area located on the second surface 12, and the earphone body 100 also includes a touch panel 50, the touch panel 50 is disposed in the housing 10, corresponding to the touch area, and is electrically connected to the circuit board 20. Thus, the user can control various functions of the earphone by touching the touch area.

In some embodiments of the present application, as shown in FIG. 5, the touch panel 50 is arranged in the accommodating chamber 16, and is arranged on a side of the circuit board 20 away from the separation plate 40. The touch area is arranged on the second surface 12, for the user to touch to control the corresponding functions.

In some embodiments of the present application, referring to FIGS. 2 and 6, the earphone body 100 also includes a sensor 60, the sensor 60 is arranged in casing 10, and specifically, the sensor 60 is arranged in accommodating chamber 16, and is electrically connected to the circuit board 20. Specifically, the sensor 60 is disposed on a side of the circuit board 20 facing the separation plate 40. Optionally, the sensor 60 is a Hall sensor, and the Hall sensor automatically switches the earphone on and off through magnetic field induction.

In some embodiments of the present application, referring to FIGS. 1, 6, and 7, the housing 10 is provided with a light-transmitting area. The earphone body 100 also includes an indicator light 70, and the indicator light 70 is arranged in the housing 10, corresponding to the light-transmitting area, and electrically connected to the circuit board 20. Therefore, the light emitted by the indicator light 70 can be displayed in the light-transmitting area to remind the user.

In some embodiments of the present application, the housing 10 is made of a translucent material, so that the light emitted by the indicator light 70 can be displayed in the light-transmitting area.

Specifically, the indicator light 70 is located between the circuit board 20 and the touch panel, and a light-transmitting hole 51 is provided on the touch panel at a position corresponding to the indicator light 70, and the light emitted by the indicator light 70 passes through the light-transmitting hole 51 and is displayed in the translucent area.

In some embodiments of the present application, the housing 10 is provided with a through hole 112, and the through hole 112 communicates with the accommodating chamber 16. The earphone body 100 also includes a charging probe 80, and the charging probe 80 is arranged inside the housing 10, one end of the charging probe 80 is electrically connected to the circuit board 20, and the other end is exposed outside the housing 10 through the through hole 112.

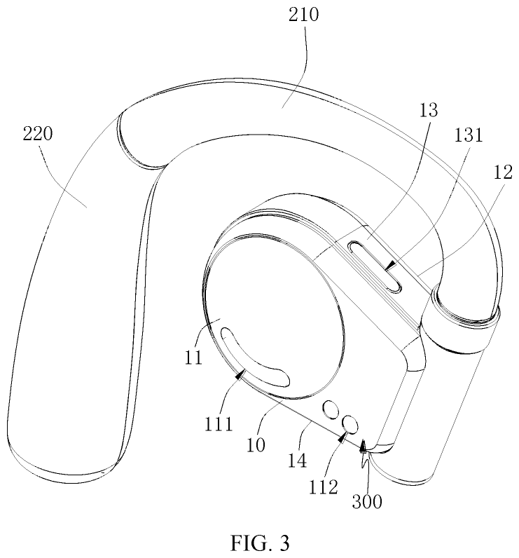

Specifically, referring to FIGS. 2 and 3, the through hole 112 extends through the first surface 11, and the charging probe 80 is disposed on the side of the circuit board 20 facing the separation plate 40.

In some embodiments of the present application, referring to FIGS. 2, 6, and 7, the earphone body 100 also includes a magnetic member 81 disposed in the accommodating chamber 16. When the earphone is placed in the earphone charging cartridge, the magnetic member 81 is attached to the earphone charging cartridge, effectively ensuring the stability of the earphone placed in the earphone charging cartridge, so that the earphone charging cartridge can charge the earphone more stably. Optionally, the magnetic member 81 is a magnet block or a metal block capable of attracting a magnet, such as iron, cobalt, nickel and their alloys or ferrite.

Specifically, the magnetic member 81 and the charging probe 80 are disposed on the same side of the circuit board 20, that is, the magnetic member 81 is disposed on the side of the circuit board 20 facing the separation plate 40.

In some embodiments of the present application, the earphone body 100 further includes an adapting member 90, and the adapting member 90 is disposed in the housing 10, specifically, the adapting member 90 is disposed in the accommodating chamber 16. One end of the adapting member 90 is electrically connected to the speaker 30 and the battery 222, and the other end is abutted on the circuit board 20.

It can be understood, by arranging the adapting member 90, during the assembly of the circuit board 20, the electrical connection between the circuit board 20, the speaker 30, and the battery 222 can be disconnected first, so as to prevent the circuit on the circuit board 20 from being damaged by the surrounding static electricity. After the circuit board 20 is assembled into the housing 10, the circuit board 20 is electrically connected to the speaker 30 and the battery 222 through the adapting member 90, that is, after the circuit board 20 is assembled into the housing 10, the circuit board 20 is electrically connected to the speaker 30 and the battery 222, which is beneficial to protect the circuit board 20 from being affected by static electricity during the assembly process, thereby ensuring the quality of the wireless earphone.

Optionally, the adapting member 90 is a flexible circuit board 20 (FPC).

Optionally, the adapting member 90 is U-shaped, Z-shaped or L-shaped.

In some embodiments of the present application, referring to FIGS. 6 and 7, the adapting member 90 includes a first connecting sheet 91, a second connecting sheet 92, and a flexible sheet 93, the first connecting sheet 91 and the second connecting sheet 92 are spaced apart facing each other, and two ends of the flexible sheet 93 are respectively connected to one end of the first connecting sheet 91 and the second connecting sheet 92, that is, the adapting member 90 is U-shaped. The first connecting sheet 91 is electrically connected to the speaker 30 through a wire, and the second connecting sheet 92 flexibly abuts on the circuit board 20 to electrically connect the circuit board 20 to the speaker 30. Specifically, the circuit board 20 is provided with a notch 21, the first connecting sheet 91 is arranged on one side of the circuit board 20, and is adhered to the inner wall of the housing 10, the flexible sheet 93 passes through the notch 21, and the second connecting sheet 92 is flexibly abutted against a side of the circuit board 20 away from the first connecting sheet 91.

In some embodiments of the present application, the first connecting sheet 91, the second connecting sheet 92, and the flexible sheet 93 are integrally formed, that is, the adapting member 90 has an integrally formed sheet-like structure.

In some embodiments of the present application, in order to ensure the strength of the first connecting sheet 91 and the second connecting sheet 92, the first connecting sheet 91 is provided with a first reinforcing sheet, and the second connecting sheet 92 is provided with a second reinforcing sheet. Optionally, both the first reinforcing sheet and the second reinforcing sheet are steel sheets.

In some embodiments of the present application, referring to FIGS. 1, 2, and 4, the cross-sectional area of the curved section 210 gradually increases from the middle part, respectively towards the two ends at the auxiliary section 220 and the earphone body 100. The cross-sectional area of the auxiliary section 220 gradually decreases toward the curved section 210, so that the ear hook 200 conforms to ergonomics, which is beneficial to further improve the stability of the ear hook 200 when worn.

It should be noted that the cross section of the curved section 210 is a radial section of the curved section 210, and the cross section of the auxiliary section 220 is a radial section of the auxiliary section 220.

Specifically, the cross section of the curved section 210 is a circular surface, and the minimum diameter of the curved section 210 is 4.0 mm-4.5 mm. Optionally, the minimum diameter of the curved section 210 is 4.0 mm, 4.1 mm, 4.2 mm, 4.3 mm, 4.4 mm or 4.5 mm.

In some embodiments of the present application, the curved section 210 is made of soft rubber material, and a shape memory wire 211 is embedded in the curved section 210. The shape memory wire 211 is flexible and has a shape memory function, which can automatically restore to the original shape after removing external forces. Therefore, when worn by the user, the shape memory wire 211 has a tendency to drive the curved section 210 to restore to the original shape, so that the curved section 210 is fitted to the contour of the user's ear, improving the stability of wearing, moreover, by adjusting the curved section 210, the fit between the earphone body 100 and the inner auricle of the user can be adjusted, thereby further improving the wearing comfort of the user.

In some embodiments of the present application, the curved section 210 is made of silicone.

In some embodiments of the present application, the material of the shape memory wire 211 is memory metal or shape memory polymer.

Optionally, the shape memory wire 211 is a memory metal wire, which not only has a shape memory effect, but also can support the curved section 210, so that the suspended section has better strength, and the curved section 210 can be supported firmly, thereby improving the stability of the earphone when worn. Specifically, the memory metal wire may be a nickel-titanium alloy wire, a copper-zinc alloy wire, a copper-aluminum-nickel alloy wire, a copper-molybdenum-nickel alloy wire, or a copper-gold-zinc alloy wire.

In some embodiments of the present application, the auxiliary section 220 is made of a mixture of polycarbonate (PC) and acrylonitrile butadiene styrene copolymers (ABS).

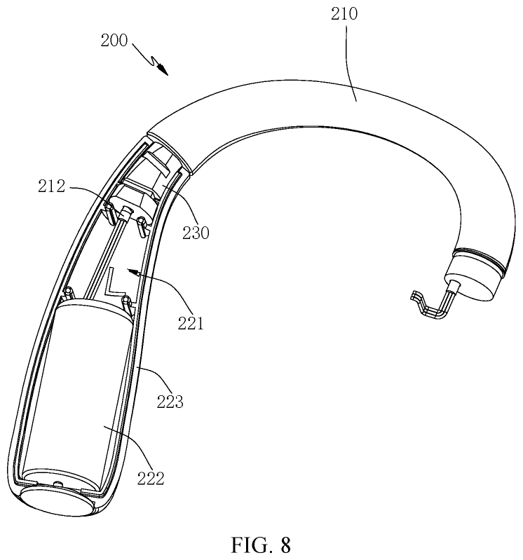

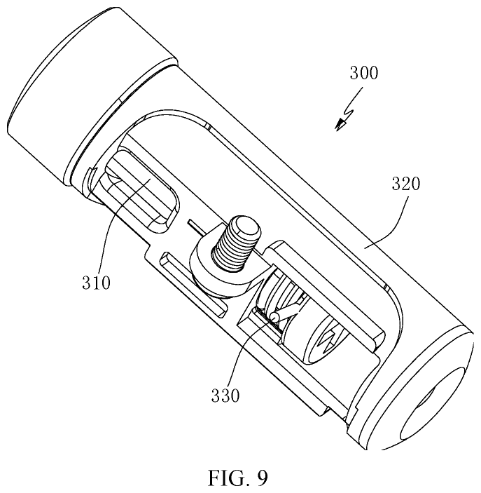

In some embodiments of the present application, referring to FIGS. 2 and 8, the auxiliary section 220 is provided with a mounting cavity 221, the mounting cavity 221 is provided with a battery 222. The curved section 210 is embedded with a wiring harness 212, one end of the wire harness 212 extends into the mounting cavity 221 and is electrically connected to the battery 222, and the other end of the wire harness 212 extends into the housing 10 and is electrically connected to the circuit board 20.

It can be understood that, the circuit board 20, the speaker 30, the touch panel 50, the sensor 60, the indicator light 70, the charging probe 80, and the magnetic member 81 are all disposed in the accommodation chamber 16 of the housing 10, only the battery 222 is disposed in the mounting cavity 221 of the auxiliary section 220 of the ear hook 200, so that the wiring harness 212 embedded in the curved section 210 only needs to electrically connect the battery 222 to the circuit board 20. Therefore, the number of the wires included in the wiring harness 212 is reduced, which minimizes the occupied area of the wiring harness 212, thereby reducing the cross-sectional area of the suspended section and making the suspended section thinner, reducing the pain of the user when wearing the earphone.

In some embodiments of the present application, the auxiliary section 220 includes a first battery case 223 and a second battery case 224, and the first battery case 223 and the second battery case 224 cooperate and are connected to form the mounting cavity 221.

In some embodiments of the present application, the wire harness 212 includes a plurality of wires. Optionally, the wire harness 212 includes three round wires.

Specifically, referring to FIG. 2, the ear hook 200 also includes a first connecting block 230 and a second connecting block 240, one end of the first connecting block 230 and one end of the second connecting block 240 are respectively connected to two ends of the curved section 210. Specifically, one end of the first connecting block 230 and one end of the second connecting block 240 are respectively embedded in the curved section 210, and the two ends of the shape memory wire 211 are connected to the first connecting block 230 and the second connecting block 240 respectively. Two ends of the wire harness 212 respectively pass through the first connecting block 230 and the second connecting block 240, and one end of the auxiliary section 220 is connected with one end of the first connecting block 230 away from the curved section 210. Specifically, the one end of the auxiliary section 220 is fixedly sleeved on the one end of the first connecting block 230 away from the curved section 210.

In some embodiments of the present application, referring to FIGS. 1, 2, and 9, the open-type earphone also includes a rotatory assembly 300, and the rotatory assembly 300 includes a connecting shaft 310, a connecting sleeve 320, and a restoring elastic member 330. One end of the connecting shaft 310 is connected to an end of the curved section 210 away from the auxiliary section 220. Specifically, the one end of the connecting shaft 310 is connected to one end of the second connecting block 240 protruding from the curved section 210. The connecting sleeve 320 is connected with the earphone body 100, specifically, a side of the connecting sleeve 320 is connected with the housing 10, the connecting sleeve 320 is movably sleeved on the connecting shaft 310, and the connecting sleeve 320 is rotatable relative to the connecting shaft 310, so that the earphone body 100 and ear hook 200 can be rotated relative to each other, which is convenient for the user to wear, and the rotation angle between the earphone body 100 and the ear hook 200 can be adaptively adjusted according to the shape of the user's ear to improve wearing comfort. The restoring elastic member 330 is disposed on the connecting shaft 310 and inside the connecting sleeve 320, and is configured to provide a restoring force to the connecting sleeve 320, so that the earphone body 100 is pressed against the inner auricle of the user when worn.

Optionally, the restoring elastic member 330 is a torsion spring, and is sleeved on the connecting shaft 310, and one end of the restoring elastic member 330 abuts the housing 10 or the connecting sleeve 320. The restoring elastic member 330 has multiple states, the first state is: when the connecting shaft 310 and the connecting sleeve 320 are in their initial position, the restoring elastic member 330 is in a pre-compressed state to provide an initial torsional force as a restoring force; the second state is: when the connecting shaft 310 and the connecting sleeve 320 are relatively rotated by an external force, the torsion of the restoring elastic member 330 is increased, and the torsional force provided is increased; the third state is: when the external force on the connecting shaft 310 and the connecting sleeve 320 is removed, the torsional force of the restoring elastic member 330 acts as a restoring force, driving the connecting shaft 310 and the connecting sleeve 320 to return to their original positions.

The above embodiments merely show optional embodiments of the present application, and cannot be interpreted as the limitation to the present application. Those skilled in the art can make various changes and modifications without departing from the spirit and scope of the present application. Any modifications, equivalent replacements, improvements, etc. made within the spirit and principles of the present application shall be included within the scope of the claims of the present application.

What is claimed is:

1. An open-type earphone, comprising:
an earphone body; and
an ear hook having a curved section and an auxiliary section;
wherein
one end of the curved section is connected to one end of the auxiliary section, and the other end of the curved section is rotatably connected to the earphone body, the curved section is made of a soft material, and the auxiliary section is made of a hard material.

2. The open-type earphone according to claim 1, wherein the curved section is a soft rubber strip.

3. The open-type earphone according to claim 1, wherein a shape memory wire is embedded in the curved section.

4. The open-type earphone according to claim 3, wherein a material of the shape memory wire is a memory metal or a shape memory polymer.

5. The open-type earphone according to claim 3, wherein the ear hook further comprises a first connecting block and a second connecting block, the first connecting block and the second connecting block are respectively embedded in the curved section, and two ends of the shape memory wire are respectively connected to the first connecting block and the second connecting block.

6. The open-type earphone according to claim 1, wherein a cross-sectional area of the curved section gradually increases in directions from a middle part toward two ends at the auxiliary section and the earphone body respectively.

7. The open-type earphone according to claim 1, wherein a cross-sectional area of the auxiliary section gradually decreases in a direction toward the curved section.

8. The open-type earphone according to any of claims 1 to 7, further comprising a rotatory assembly,
wherein the rotatory assembly comprises a connecting shaft, a connecting sleeve and a restoring elastic member, the connecting sleeve is movably sleeved on the connecting shaft, the connecting shaft is connected to the curved section, and the connecting sleeve is connected to the earphone body, the restoring elastic member is disposed on the connecting shaft and inside the connecting sleeve, and the restoring elastic member is configured to provide a restoring force to the connecting sleeve.

9. The open-type earphone according to claim 8, wherein the restoring elastic member is a torsion spring and is sleeved on the connecting shaft, and one end of the restoring elastic member is abutted against the earphone body or the connecting sleeve.

10. The open-type earphone according to any of claims 1 to 7, wherein the earphone body comprises a housing, a circuit board, and a speaker, the housing is provided with a sound outlet hole and a tuning hole, the circuit board and the speaker are disposed in the housing, and the speaker and the circuit board are electrically connected.

11. The open-type earphone according to claim 10, wherein a first dust-proof net is provided at the sound outlet; and/or, a second dust-proof net is provided at the tuning hole.

12. The open-type earphone according to claim 10, wherein a light-transmitting area is provided on the housing, and the earphone body further comprises an indicator light arranged in the housing, the indicator light is positioned corresponding to the light-transmitting area and is electrically connected to the circuit board.

13. The open-type earphone according to claim 10, wherein the earphone body further comprises a magnetic member, the magnetic member is arranged in the housing, so that when the open-type earphone is placed in an earphone charging cartridge, the magnetic member attracts the earphone charging cartridge.

14. The open-type earphone according to claim 10, wherein a mounting cavity is provided in the auxiliary section, a battery is arranged in the mounting cavity, and a wiring harness is embedded in the curved section, one end of the wiring harness extends into the mounting cavity and is electrically connected to the battery, and the other end of the wiring harness extends into the housing and is electrically connected to the circuit board.

15. The open-type earphone according to claim 10, wherein the earphone body further comprises an adapting member, the adapting member is disposed in the housing, one end of the adapting member is electrically connected to the speaker, and the other end is abutted against the circuit board.

16. The open-type earphone according to claim 15, wherein the adapting member comprises a first connecting sheet, a second connecting sheet, and a flexible piece, the first connecting sheet and the second connecting sheet are spaced apart facing each other, and two ends of the flexible piece are respectively connected to one end of the first connecting sheet and the second connecting sheet, the first connecting sheet is electrically connected to the speaker, and the second connecting sheet is flexibly abutted on the circuit board.

17. The open-type earphone according to claim 10, wherein the earphone body further comprises a separation plate, and the separation plate is arranged in the housing to separate an interior of the housing into a sound chamber and an accommodating chamber, the circuit board is arranged in the accommodating chamber, and the speaker is arranged in the sound chamber, the sound outlet hole and the tuning hole are both in communication with the sound chamber.

18. The open-type earphone according to claim 17, wherein the separation plate is recessed from the speaker toward the circuit board to form a recess, and a part of the speaker is disposed in the recess.

19. The open-type earphone according to claim 10, wherein a touch area is provided on the housing, and the earphone body further comprises a touch panel, the touch panel is disposed in the housing, corresponding to the touch area, and the touch panel is electrically connected to the circuit board.

20. The open-type earphone according to claim 19, wherein the housing is provided with a first surface and a second surface facing away from each other, the sound outlet hole extends through the first surface, and the touch area is arranged on the second surface.
